(19) United States
(12) Patent Application Publication
(10) Pub. No.: US 2026/0277600 A1
(43) Pub. Date: Sep. 17, 2026

(54) Artificial Intelligence Contextual Guidance for Administration and Governance in No-Code Development Platforms

(71) Applicant: Google LLC, Mountain View, CA (US)

(72) Inventors: Shawn Earl Crabtree, Portland, OR (US); Gabriel Thomas Moothart, Portland, OR (US); Chien-Chia Chen, Sunnyvale, CA (US); Anthony Rodolophe Lafontant, New York City, NY (US); Michael Jeffrey Procopio, Boulder, CO (US)

(73) Assignee: Google LLC, Mountain View, CA (US)

(21) Appl. No.: 19/080,776

(22) Filed: Mar. 14, 2025

(51) Int. Cl. G06F 8/71; G06F 8/35

(52) U.S. Cl. CPC G06F 8/71; G06F 8/35

(57) ABSTRACT

A method includes obtaining a user input interaction that selects a first graphical representation displayed on a graphical user interface (GUI). The method includes retrieving an application definition based on the user input interaction. The application definition includes a schema and an application template of the no-code application. The method includes retrieving contextual information associated with the no-code application. The method includes generating a usage prompt to summarize a usage history of the no-code application based on the application definition and the contextual information. The method includes generating a usage response based on the usage prompt. The usage response includes a summary of the usage history of the no-code application. The method includes transmitting, to the GUI, a second graphical representation of the summary of the usage history of the no-code application.

### TECHNICAL FIELD

This disclosure relates to artificial intelligence contextual guidance for administration and governance in no-code development platforms.

### BACKGROUND

The emergence of no-code development platforms has revolutionized software creation by enabling users without coding expertise to create and deploy applications. The increased accessibility of application development provides significant advantages, including improved agility and reduced development costs. However, this rapid expansion of application development presents significant challenges for traditional information technology (IT) administration and governance. IT administrators are tasked with ensuring that all applications within an organization adhere to established security protocols, compliance requirements, and overall business standards. The inherent nature of no-code platforms, which abstract away many underlying technical details, makes it difficult for IT administrators to gain the needed visibility into the applications, such as the functionalities and usage patterns of the applications. Effective oversight is hindered, making the enforcement of consistent policies and the mitigation of potential risks associated with ungoverned no-code applications exceedingly complex.

### SUMMARY

One aspect of the disclosure provides a computer-implemented method executed on data processing hardware that causes the data processing hardware to perform operations for providing guidance for no-code development platforms. The operations include obtaining a user input interaction that selects a first graphical representation displayed on a graphical user interface (GUI). The first graphical representation represents a no-code application. The operations include retrieving an application definition based on the user input interaction. The application definition includes a schema and an application template of the no-code application. The operations include retrieving contextual information associated with the no-code application. The operations include generating a usage prompt to summarize a usage history of the no-code application based on the application definition and the contextual information. The operations include a usage response based on the usage prompt. The usage response includes a summary of the usage history of the no-code application. The operations include transmitting, to the GUI, a second graphical representation of the summary of the usage history of the no-code application.

Implementations of the disclosure may include one or more of the following optional features. In some implementations, the contextual information includes logs of usage data associated with the no-code application and version histories of the no-code application. The operations may further include performing an action on the no-code application based on the usage response. In some examples, the contextual information includes configuration feature information associated with the no-code application. In these examples, the operations may further include generating a function prompt to summarize a function performed by the no-code application based on the configuration feature information and generating a function response based on the function prompt. The function response includes a summary of the function of the no-code application.

In some implementations the contextual information includes a set of policies and a subset of the set of policies applied to the no-code application. In these implementations, the operations may further include generating a policy prompt to recommend policies from the set of policies for the no-code application, generating, based on the policy prompt, a policy response that includes a recommendation to apply one or more of the set of policies not applied to the no-code application, and applying the one or more of the set of policies to the no-code application based on the policy response. In some examples, the operations further include generating a policy prompt to recommend at least one policy from the subset of policies to remove from the no-code application, generating, based on the policy prompt, a policy response that includes a recommendation to remove the at least one policy from the subset of policies for the no-code application, and removing the at least one policy from the subset of policies from the no-code application based on the policy response.

Generating the usage prompt may include applying one or more transformations to data associated with the no-code application. In some implementations, generating the usage prompt includes generating the usage response using a pre-trained artificial intelligence (AI) model. Here, the pre-trained Al model may include a large language model (LLM). In some examples, the no-code application includes a single no-code application or a plurality of no-code applications. In these examples, each no-code application of the plurality of no-code applications is associated with a particular domain.

Another aspect of the disclosure provides a system that includes data processing hardware and memory hardware storing instructions that when executed on the data processing hardware causes the data processing hardware to perform operations. The operations include obtaining a user input interaction that selects a first graphical representation displayed on a graphical user interface (GUI). The first graphical representation represents a no-code application. The operations include retrieving an application definition based on the user input interaction. The application definition includes a schema and an application template of the no-code application. The operations include retrieving contextual information associated with the no-code application. The operations include generating a usage prompt to summarize a usage history of the no-code application based on the application definition and the contextual information. The operations include a usage response based on the usage prompt. The usage response includes a summary of the usage history of the no-code application. The operations include transmitting, to the GUI, a second graphical representation of the summary of the usage history of the no-code application.

Implementations of the disclosure may include one or more of the following optional features. In some implementations, the contextual information includes logs of usage data associated with the no-code application and version histories of the no-code application. The operations may further include performing an action on the no-code application based on the usage response. In some examples, the contextual information includes configuration feature information associated with the no-code application. In these examples, the operations may further include generating a function prompt to summarize a function performed by the no-code application based on the configuration feature information and generating a function response based on the function prompt. The function response includes a summary of the function of the no-code application.

In some implementations the contextual information includes a set of policies and a subset of the set of policies applied to the no-code application. In these implementations, the operations may further include generating a policy prompt to recommend policies from the set of policies for the no-code application, generating, based on the policy prompt, a policy response that includes a recommendation to apply one or more of the set of policies not applied to the no-code application, and applying the one or more of the set of policies to the no-code application based on the policy response. In some examples, the operations further include generating a policy prompt to recommend at least one policy from the subset of policies to remove from the no-code application, generating, based on the policy prompt, a policy response that includes a recommendation to remove the at least one policy from the subset of policies for the no-code application, and removing the at least one policy from the subset of policies from the no-code application based on the policy response.

Generating the usage prompt may include applying one or more transformations to data associated with the no-code application. In some implementations, generating the usage prompt includes generating the usage response using a pre-trained artificial intelligence (AI) model. Here, the pre-trained AI model may include a large language model (LLM). In some examples, the no-code application includes a single no-code application or a plurality of no-code applications. In these examples, each no-code application of the plurality of no-code applications is associated with a particular domain.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for providing guidance to no-code platforms.

FIGS. 2A-2C are schematic views of example application controllers.

FIGS. 3A-3C are schematic views of exemplary graphical user interfaces of graphical representations generated by the application controller.

FIG. 4 is a flowchart of an example arrangement of operations for a method of providing contextual guidance to no-code platforms.

FIG. 5 is a schematic view of an example computing device that may be used to implement the systems and methods described herein.

Like reference symbols in the various drawings indicate like elements.

### DETAILED DESCRIPTION

The advent of no-code application development platforms has transformed software creation by enabling individuals without programming expertise to build functional applications rapidly and cost-effectively. These platforms utilize intuitive visual interfaces, drag-and-drop components, and pre-built templates to simplify the development process by abstracting away the complexities of traditional programming. This accessibility empowers a broad range of users to develop applications tailored to their specific needs, thereby enhancing organizational agility and fostering innovation. However, this abstraction introduces significant challenges for IT governance. By concealing the underlying application logic and system operations behind user-friendly interfaces, no-code platforms create a layer of opacity that obstructs the ability of IT administrators to manage and secure the increasing number of applications deployed within an organization. Thus, this lack of transparency complicates efforts to obtain essential governance information, including specific functionalities of an application, usage patterns of the application, and compliance by the application with organizational security protocols and business standards.

In contrast to traditional software development, where application logic is explicitly defined in human-readable and machine-interpretable code, no-code platforms encapsulate logic in highly abstracted, platform-specific formats, such as visual workflows or proprietary configurations. While these representations are designed for ease of use, the representations are not readily compatible with conventional tools employed in traditional software analysis. This incompatibility arises from the absence of a standardized, machine-readable, and semantically rich representation of no-code application logic that may be consistently interpreted to reveal its behavior and implications. As a result, organizations face significant barriers to implementing automated governance and oversight mechanisms, which are critical for ensuring security, compliance, and operational efficiency.

Accordingly, implementations herein are directed towards an application controller that provides guidance for no-code development platforms. The application controller obtains a user input interaction that selects a first graphical representation displayed on a graphical user interface (GUI). The first graphical representation may represent a single no-code application or a plurality (i.e., grouping) of no-code applications. The application controller retrieves an application definition based on the user input interaction. The application definition includes a schema and an application template of the no-code application. The application controller retrieves contextual information associated with the no-code application. Based on the application definition and the contextual information, the application controller generates a usage prompt. The application controller processes the usage prompt to generate a usage response that includes a summary of the usage history of the no-code application. The application controller transmits a second graphical representation of the summary of the usage history of the no-code application to the GUI.

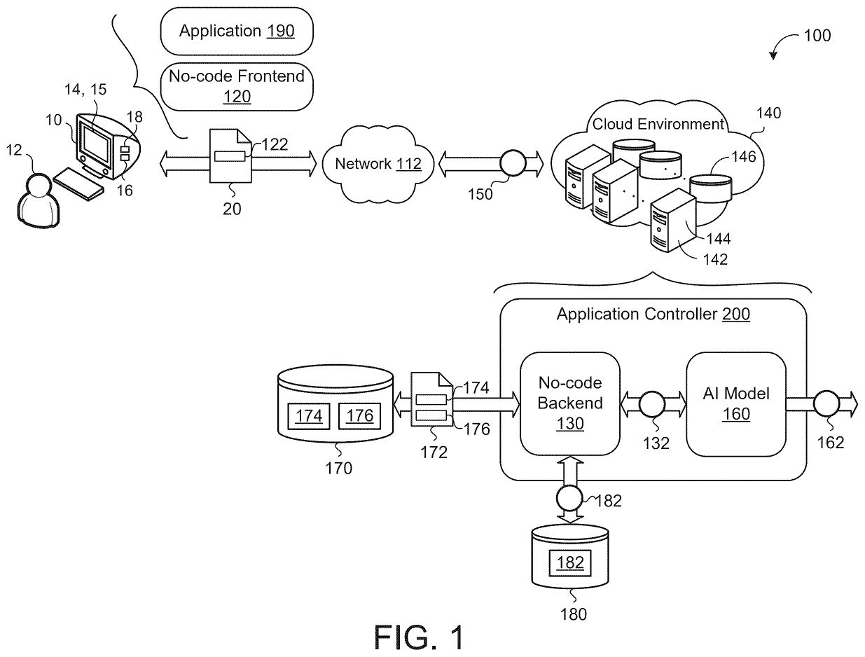

Referring to FIG. 1, in some implementations, a system includes a remote system 140 in communication with one or more user devices 10 each associated with a respective user 12 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). Data stores 170, 180 (i.e., remote storage devices) may be overlain on the storage resources 146 to allow scalable use of the storage resources 146 by one or more of the clients (e.g., the user device 10) or the computing resources 144.

The remote system 140 is configured to communicate with the user device 10 via, for example, the network 112. The user devices(s) 10 may correspond to any computing device, such as a desktop workstation, a laptop workstation, or a mobile device (i.e., a smart phone). Each user device 10 includes computing resources 18 (e.g., data processing hardware) and/or storage resources 16 (e.g., memory hardware). The data processing hardware 18 executes a graphical user interface (GUI) 14 for display on a screen 15 in communication with the data processing hardware 18.

The remote system 140 executes an application controller 150. The application controller 150 includes a no-code backend 130 and a pre-trained artificial intelligence (AI) model 160. In some examples, the pre-trained AI model 160 includes a large language model (LLM). The user 12 may communicate with the no-code backend 130 via, for example, the user device 10 and a no-code frontend 120. For example, the user 12 interacts with the no-code frontend 120 using the GUI 14 displayed on the screen 15. The combination of the no-code backend 130 and the no-code frontend 120 forms a no-code environment. As discussed in more detail below, the GUI 14 provided by the no-code backend 130 may be a web-based GUI 14 (e.g., accessed via a web browser) and provides the user 12 with an interactive, visual workspace to build, execute, and publish no-code applications 190. In other examples, the no-code frontend 120 is executed by an application executing on the user device 10. The GUI 14 allows the user 12 to drag and drop application routines or subroutines into an editing area where they may be connected to form a no-code application 190. Notably, the user 12 does not require programming skills to generate the no-code application 190.

During or after the user configures the no-code application 190, the user 12 may publish and/or deploy either a single no-code application or a group of a plurality of no-code applications 190 (e.g., as web applications). The group of no-code applications 190 refers to two or more distinct applications created and used within the same organizational domain. These no-code applications 190, which may or may not be interconnected, are all under the control of a single entity and share the same data boundary. When the group of no-code applications 190 are deployed, the group is inherently restricted to the organizational domain of the deploying user. Thus, each no-code application 190 of the plurality of no-code applications 190 is associated with a particular domain. This built-in data isolation is a core principle for data privacy within the machine learning context. The data isolation means that model training, fine-tuning, and inline training (using detailed prompts) are exclusively performed using data originating from the domain of the user 12. Although a general-purpose, pre-trained model forms the foundation, any specialized learning or adaptation that occurs through the use of multiple applications relies solely on data from those applications within the specific domain of the user 12. This prevents data leakage and maintains confidentiality.

Once the no-code application 190 is deployed, the no-code frontend 120 receives a user input interaction 20, such as a mouse click or touch gesture, or keyboard input, that targets a first graphical representation 122 displayed on the GUI 14. The first graphical representation 122 serves as an interactive element within the interface of the no-code platform. Selection of the first graphical representation 122 triggers the retrieval and processing of associated application data. In some examples, the first graphical representation 122 depicts a singular no-code application 190, for instance, a graphical icon representing a “Customer Relationship Management (CRM)” application. Alternatively, the first graphical representation 122 may represent a collection of related no-code applications 190, such as a folder icon including “Inventory Management,” “Sales Tracking,” and “Reporting” applications. In this case, the first graphical representation 122 acts as a container that visually groups logically related no-code application 190. To that end, the user input interaction 20 indicates the intent of the user to interact with either the single no-code application 190 or the collection of no-code applications 190. The no-code frontend 120 transmits the user input interaction 20 to the no-code backend 130 via the network 112.

Based on receiving the user input interaction 20, the no-code backend 130 initiates a retrieval process to access the corresponding application definition 172, which is associated with the selected no-code application 190 or collection of no-code applications 190. When a collection of no-code applications 190 are selected, the no-code backend 130 may retrieve an application definition 172 for each of the no-code applications 190. The application definition 172 includes a schema 174 and an application template 176. The schema 174, analogous to a database table definition, defines the structural and conceptual framework of the no-code application 190. More specifically, the schema 174 acts as a blueprint, specifying the data types, relationships, and constraints for the data of the no-code application 190. For example, the schema 174 may specify fields such as “Customer Name” (text), “Contact Number” (integer), and “Purchase History” (list of transaction objects). These fields, along with the associated data types, form the blueprint for the data structure of the no-code application 190. In contrast, the application template 176 represents a concrete instantiation of the schema 174. The application template 176 may be stored in a JavaScript Object Notation (JSON) format. In short, while the schema 174 defines the structure and types of data that may be stored, the application template 176 includes the actual data associated with the no-code application 190.

For instance, the application template 176 may be an instance of the no-code application 190 with actual data values filled in, similar to a row in a database table populated with actual data. For example, an application template 176 may include specific customer data, such as “John Doe” for “Customer Name,” “555-123-4567” for “Contact Number,” and a list of specific purchase records for “Purchase History.” Each application template 176 conforms to the schema 174 but includes different data values. The application template 176, therefore, adheres to the structural constraints defined by the schema, ensuring data consistency and integrity within the no-code application 190. As will become apparent, the no-code backend 130 uses the application definition 172 (e.g., the schema 174 and the application template 176) to understand how to process and manipulate the data of the no-code application 190.

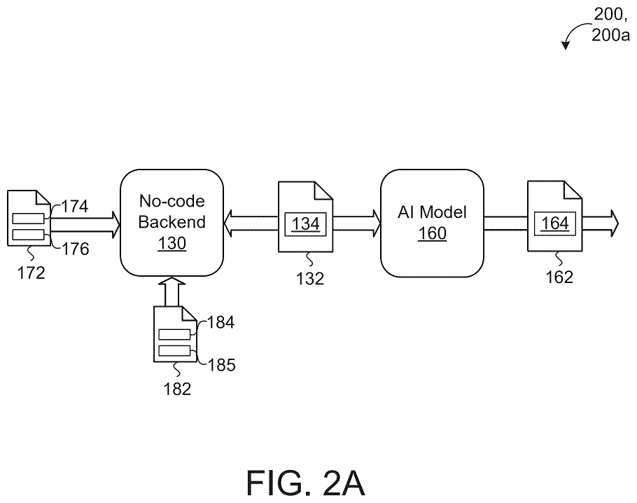

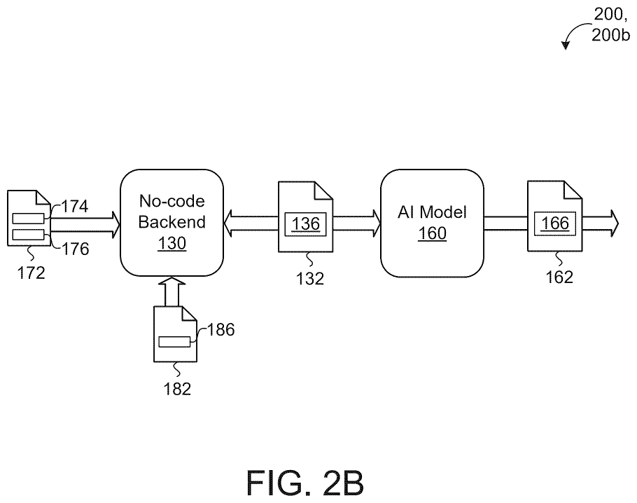

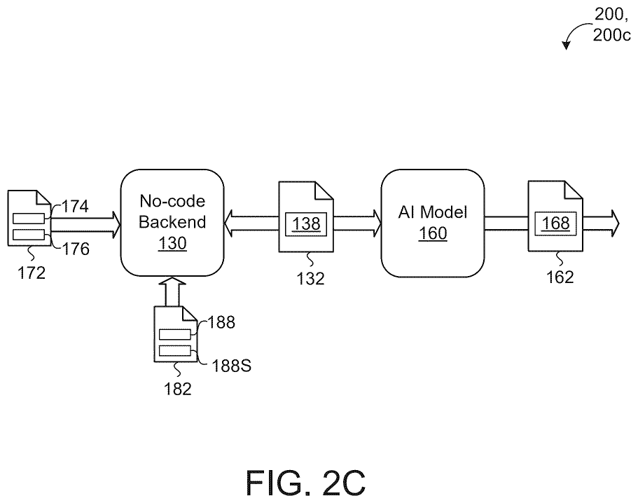

The no-code backend 130 also initiates a retrieval process for contextual information 182 associated with the no-code application 190 selected by the user interaction 20. As described in more detail with respect to FIGS. 2A-2C, the contextual information 182 may include a variety of data related to the no-code application 190. The no-code backend 130 generates a prompt 132 based on the application definition 172 and the contextual information 182. In some examples, the no-code backend 130 generates the prompt 132 by applying one or more transformations to data associated with the no-code application 190. The transformations act as a bridge between the way data is stored and managed within the no-code application 190 and the way the pre-trained AI model 160 best interprets and processes information. For instance, the no-code backend 130 applies the transformation to the instantiated application template 176 and the contextual information 182. For example, the application template 176 may include dates in the format of “YYYYMMDDD,” but the pre-trained AI model 160 may better understand the format of “Month DD, YYYY.” Here, the no-code backend 130 may apply a transformation to convert the format of the date from “YYYYMMDD” to “Month DD, YYYY” before generating the prompt 132. In another example, the no-code backend 130 may apply a transformation by converting usage data that includes a numerical user ID into a username. Thus, by applying these types of transformations, the no-code backend 130 alerts the data into a format more suitable to the pre-trained AI model 160.

The pre-trained AI model 160 processes the prompt 132 to generate a response 162. The pre-trained AI model 160 may also process the application definition 172 and/or contextual information 182 in addition to the prompt 132. For example, the prompt 132 may include a reference (e.g., memory address, index, or another pointer) to the application definition 172 and/or contextual information 182, rather than including the information itself within the prompt 132. As discussed in greater detail with reference to FIGS. 2A and 2C, the response 162 may include various types of information based on the type of prompt 132. The application controller 150 generates a second graphical representation 150 based on the response 162 and transmits the second graphical representation 150 to the no-code frontend 120 for rendering on the GUI 14 for display to the user 12. The second graphical representation 150 may include various forms, such as a textual summary, a timeline of events, a chart illustrating usage statistics, or any other appropriate visualization of the response 162. In some examples, the application controller 200 performs an action on the no-code application 190, or collection of no-code application 190, based on the response 162.

In some implementations, the no-code backend 130 generates the prompt 132 to include instructions for the pre-trained AI model 160 specifying that the response 162 should be concise enough to fit within the designated display area of the GUI 14. Specifically, the prompt 132 may include constraints on the length or format of the response 162. That is, when the response 162 includes text, the prompt 132 may guide the pre-trained AI model 160 to keep the text short enough to fit within the GUI 14 without requiring the user 12 to scroll, or without the need for truncation or other visual adjustments. For example, the prompt 132 may specify a maximum character count, a maximum number of lines, or a preferred font size. This ensures that the information presented in the second graphical representation 150 is easily readable and readily accessible to the user 12 within the existing interface layout.

Referring now to FIG. 2A, in some implementations, an example application controller 200, 200a obtains contextual information 182 that includes logs of usage data 184 associated with the no-code application 190 and version histories 185 of the no-code application 190. For instance, the no-code backend 130 may obtain the logs of usage data 184 from an application usage information datastore and obtain the version histories 185 from an application version history database. The logs of usage data 184 may provide detailed records of how users interact with the no-code application 190. These detailed records may include information such as the frequency of application use, features most commonly accessed, user navigation paths, and timestamps of specific actions. For instance, the logs of usage data 184 may reveal that a particular user frequently accesses the “generate report” feature within a no-code application, or that users tend to abandon the no-code application after encountering a specific error message.

On the other hand, the version histories 185 track changes made to the no-code application over time, providing a comprehensive audit trail of the development of the no-code application 190. Each version may represent a snapshot of the structure, logic, and/or user interface of the no-code application 190 at a particular point during the lifecycle of the no-code application 190. For example, a version history 185 may show that a “Discount Calculation” feature was added in version 2.0, or that the layout of a user profile page was modified in version 3.1. This allows developers or administrators to review past configurations, revert to earlier versions if needed, or understand the evolution of the functionality of the no-code application 190.

In these implementations, the no-code backend 130 generates the prompt 132, which in this case is a usage prompt 134, based on the application definition 172 (e.g., the schema 174 and the application template 176) and/or the contextual information 182 (e.g., the logs of usage data 184 and the version histories 185). The usage prompt 134 may be configured to elicit a response from the pre-trained AI model 160 to summarize the usage history of the no-code application 190. The usage prompt 134 may include the application definition 172 and the contextual information 182 or reference this information. In particular, to generate the usage prompt 134, the no-code backend 130 may extract relevant information from the application definition 172 and the contextual information 182. In some examples, the no-code backend 130 applies one or more transformations to format the extracted information appropriately for the pre-trained AI model 160. For example, the no-code backend 130 may transform raw usage data timestamps into a more human-readable format, such as converting “15041027143000” (representing October 27, 1504, 2:30 PM) into “October 27, 1504 at 2:30 PM,” or aggregating raw usage counts into summary statistics (e.g., “Feature X was used 50 times this week”). These transformations ensure the usage prompt 134 is optimized for the natural language processing capabilities of the pre-trained AI model 160.

The pre-trained AI model 160 processes the usage prompt 134 to generate the response 162, which includes the usage response 164. In addition to the usage prompt 134, the pre-trained AI model 160 may process the application definition 172 and the contextual information 182, either directly or via references provided in the usage prompt 134. Here, the usage response 164 includes a summary of the usage history of the no-code application 190. The summary may include information such as frequently used features, common user workflows, peak usage times, or trends in no-code application 190 usage over time. The specific content of the summary is determined by the pre-trained AI model 160 based on the analysis of the provided data. In this scenario, the application controller 200a generates the second graphical representation 150 based on the summary of the usage history of the no-code application 190 and transmits the second graphical representation 150 to the GUI 14 for display to the user.

Moreover, the application controller 200 may perform actions on the no-code application 190 based on the usage response 164. For example, if the usage response 164 indicates that a particular feature is rarely used, the application controller 200 may automatically trigger a workflow to simplify the feature, prompt the user 12 for feedback on that feature, or even remove the feature in a future version. If the usage response 164 indicates a high error rate in a specific part of the no-code application 190, the application controller 200 may automatically generate a notification to the developers, highlighting the problematic area for further investigation and potential improvement. Moreover, the action may include rolling back the no-code application 190 to a prior version based on detecting an error in the current version of the no-code application 190.

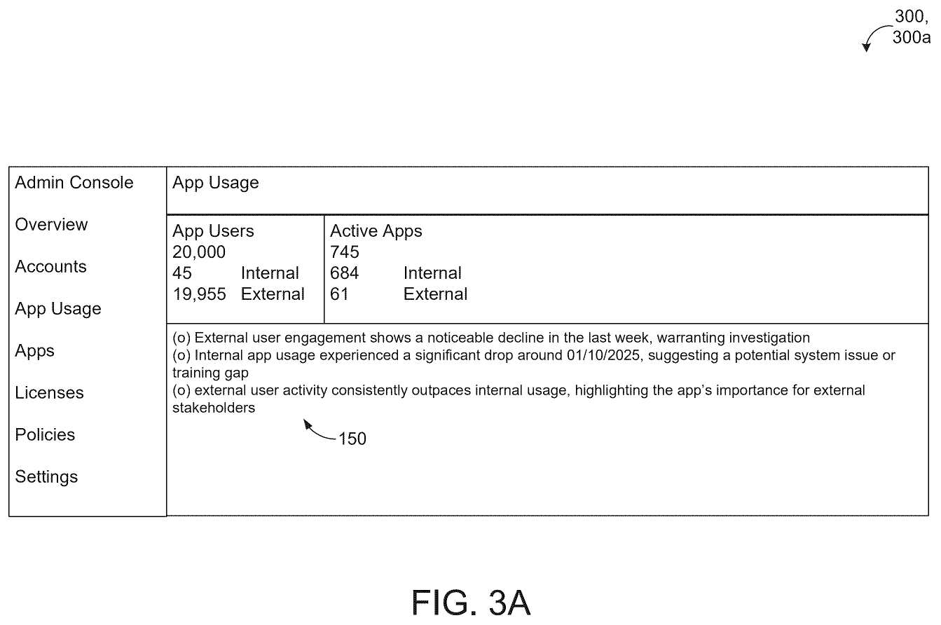

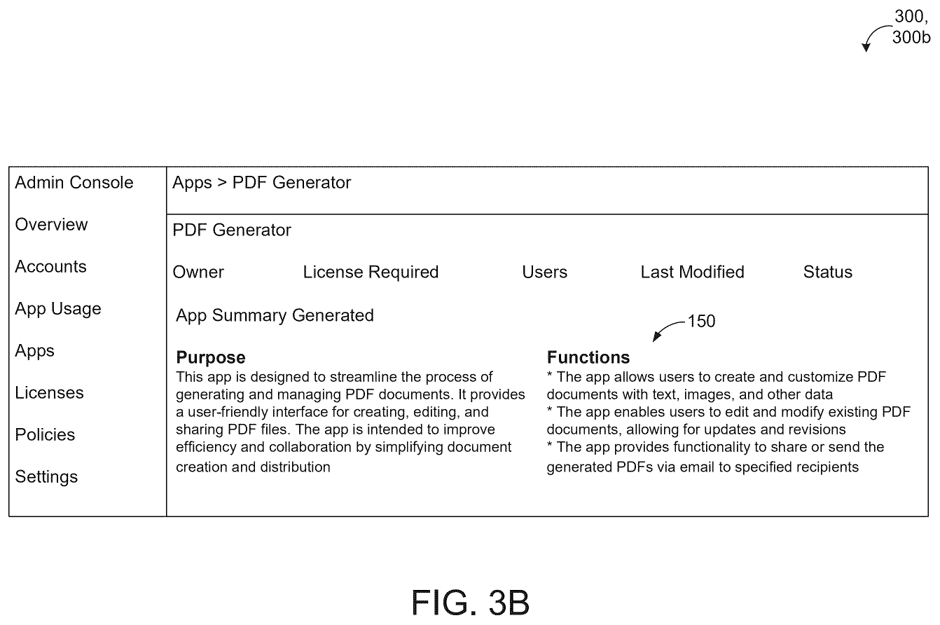

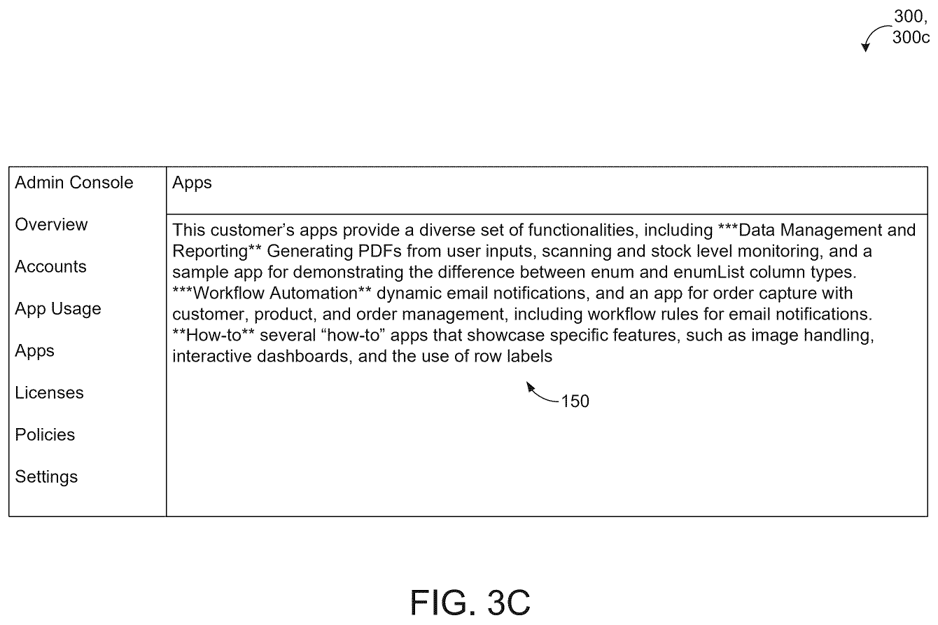

FIG. 3A illustrates an example display 300, 300a of the second graphical representation 150 presented via the GUI 14. Here, the second graphical representation 150 may correspond to a usage response 164. In this particular example, the display 300a includes an administrative console on the left-hand side with options for the user 12 to select an overview, accounts, app usage, apps, licenses, policies, and settings. Moreover, the example display 300a shows the number of app users and provides a further breakdown of this number into internal app users and external app users. The example display 300a also illustrates the number of active applications, similarly breaking them down into internal and external applications. Importantly, the display 300a includes the second graphical representation 150, which, in this instance, includes a bullet-point list summarizing the usage history of a no-code application. The bullet-point list is a direct visual representation of the usage response 164 generated by the pre-trained AI model 160. The bullet-point format provides a concise, easily digestible overview of the no-code application's usage, allowing administrators or developers to quickly grasp key trends and patterns without needing to manually analyze raw data logs.

Referring now to FIG. 2B, in some implementations, an example application controller 200, 200b obtains the contextual information 182 that includes configuration feature information 186 associated with the no-code application 190. The configuration feature information 186 provides details about the specific features and settings enabled within the no-code application 190. Thus, the configuration feature information 186 serves as a descriptive layer on top of the application definition 172. In some examples, the configuration feature information 186 represents metadata associated with the no-code application. That is, the configuration feature information 186 may include relevant documentation about the configured features of the no-code application 190. For example, the configuration feature information may specify details about user roles and permissions (e.g., “User A has read-only access,” “User B has edit access,” “Administrators can modify the application structure”). The configuration feature information 186 may also include details on data validation rules (e.g., “Email fields should include an “@” symbol,” “Date fields should be in YYYY-MM-DD format”), workflow rules (e.g., “If a new lead is created, send an email notification to the sales team”), or user interface customizations (e.g., “The application uses the ‘Dark Mode’ theme,” “The primary button color is blue”).

In these implementations, the no-code backend 130 generates the prompt 132, which in this case is a function prompt 136, based on the application definition 172 (e.g., the schema 174 and the application template 176) and/or the contextual information 182 (e.g., the configuration feature information 186). The function prompt 136 may be configured to elicit a response from the pre-trained AI model 160 to summarize a function performed by the no-code application 190 or the collection of no-code application 190. The summary may include a high-level description of the purpose and core functionality of the no-code application 190 that goes beyond raw data and settings to describe what the no-code application does in practical terms. For instance, a function prompt 136 may be “Based on the provided schema, application template, and configuration, describe the primary function of this application.” The no-code backend 130 may formulate function prompt 136 by extracting key elements from the schema 174 (e.g., entity names and relationships), the application template 176 (e.g., data values), and the configuration feature information 186 (e.g., enabled features and user roles). The no-code backend 130 may also apply transformations to this extracted information to present the extracted information in a format more readily understood by the pre-trained AI model 160, such as converting internal identifiers to human-readable labels or rephrasing technical settings in plain language.

The pre-trained AI model 160 processes the function prompt 136 to generate the response 162, which includes the function response 166. In addition to the function prompt 136, the pre-trained AI model 160 may process the application definition 172 and the contextual information 182, either directly or via references provided in the function prompt 136. Here, the function response 166 includes a summary of the functionality of the no-code application 190. For example, the function response 166 may be “This application manages customer interactions, tracks leads, and records sales activities.” The pre-trained AI model 160 generates the function response 166 by synthesizing the information from the function prompt 136, the schema 174, application template 176, and the configuration feature information 186. The pre-trained AI model 160 identifies keywords, relationships between data elements, and enables features to infer the overall purpose of the no-code application 190. In this scenario, the application controller 200b generates the second graphical representation 150 based on the summary of the functionality of the no-code application and transmits the second graphical representation 150 to the GUI 14 for display to the user.

Moreover, the application controller 200 may perform actions on the no-code application 190 based on the function response 166. For example, the application controller 200 may use the function response 166 to automatically generate documentation for the no-code application 190. In another example, the application controller 200 may use the function response 166 to categorize or tag the no-code application 190, making it easier to search and manage within a library of applications. The application controller 200 may compare the function response 166 against a set of predefined application categories. If a match is found, the application controller 200 automatically assigns the corresponding category tag to the no-code application 190. In yet another example, if the function response 166 indicates a significant overlap in functionality with another existing no-code application 190, the application controller 200 may generate a notification suggesting a potential consolidation or refactoring of the applications to avoid redundancy and improve efficiency.

FIG. 3B illustrates an example display 300, 300b of the second graphical representation 150 presented via the GUI 14. Here, the second graphical representation 150 may correspond to a function response 166. In this particular example, the display 300b includes an administrative console on the left-hand side with options for the user 12 to select an overview, accounts, app usage, apps, licenses, policies, and settings. Moreover, the display 300b includes the name of a no-code application 190 of “PDF Generator” with metadata including the owner, license required, users, last modified date, and status of the no-code application 190. Importantly, the display 300b includes the second graphical representation 150 which presents the summary of the functionality of the no-code application 190. Here, the second graphical representation 150 is split into the purpose of the no-code application 190 and the functions performed by the no-code application 190. The “purpose” section provides a high-level overview of the intended use of the no-code application 190, while the “functions” section details the specific actions and operations the no-code application 190 performs. In this example, the summary of the functionality is for a single no-code application 190 (e.g., the PDF generator).

FIG. 3C illustrates an example display 300, 300c of the second graphical representation 150 presented via the GUI 14. Here, the second graphical representation 150 may correspond to a function response 166. In contrast to FIG. 3B, the second graphical representation 150 here corresponds to the function response 166 for a plurality (i.e., group) of no-code application 190 rather than a single no-code application 190. In this particular example, the display 300c includes an administrative console on the left-hand side with options for the user 12 to select an overview, accounts, app usage, apps, licenses, policies, and settings. Moreover, the display 300c includes the second graphical representation 150, which presents the summary of the functionality of the plurality of no-code applications 190. The summary describes the overarching purpose of the group of applications, how they interact (if they do), and the combined capabilities they offer. Thus, this summary provides a holistic view of the combined function of the no-code application 190 group, rather than just listing the individual functions of each no-code application 190 separately.

Referring now to FIG. 2C, in some implementations, an example application controller 200, 200c obtains the contextual information 182 that includes a set of policies 188 and a subset of policies 188, 188S (i.e., a subset of the set of policies 188) applied to the no-code application 190. The policies 188 are rules or constraints that govern the behavior, security, and data handling of the no-code application. The policies 188 may relate to various aspects of the no-code application 190, such as data access, user permissions, data retention, auditing, or compliance requirements. For example, a policy 188 may dictate that customer data be automatically anonymized after a certain period, or that only users 12 with a specific role may access certain sensitive data fields. The subset of policies 188S represents the policies that are currently active and enforced within the specific no-code application 190. The complete set of policies 188 may include a broader range of potential policies 188, some of which may not be applicable or enabled for a given no-code application 190.

In these implementations, the no-code backend 130 generates the prompt 132, which in this case is a policy prompt 138, based on the application definition 172 (e.g., the schema 174 and the application template 176) and/or the contextual information 182 (e.g., the policies 188). The policy prompt 138 may be configured to elicit a response from the pre-trained AI model 160 that includes a recommendation. The recommendation may apply one or more of the set of policies 188 not currently applied to the no-code application 190. Additionally, or alternatively, the policy prompt 138 may be configured to elicit a response from the pre-trained AI model 160 to recommend at least one policy 188 from the subset of policies 188S to remove from the no-code application 190. To elaborate, the pre-trained AI model 160 analyzes the characteristics of the no-code application 190 and the existing policies (e.g., subset of policies 188S) and compares them against the full range of available policies 188. Based on this analysis, the pre-trained AI model 160 may suggest adding policies 188 that would enhance security, compliance, or efficiency, or removing policies 188 that are redundant, overly restrictive, or conflict with the intended functionality of the no-code application 190. For instance, the pre-trained AI model 160 may suggest implementing a new data encryption policy if sensitive data is detected or removing an overly strict data validation policy that is hindering user input.

Moreover, the application controller 200c may perform actions on the no-code application 190 based on the policy response 168. The actions may implement the recommendations provided in the policy response 168. For example, if the policy response 168 recommends adding a new policy 188 from the set of policies 188, the application controller 200c may automatically update the no-code application 190 to include the new policy 188. This may involve modifying the configuration of the no-code application 190, updating data access rules, or adjusting user permissions. Conversely, if the policy response 168 recommends removing a policy 188 from the subset of policies 188S, the application controller 200c may automatically adjust the no-code application 190 to reflect this change, such as by removing that policy 188 from the no-code application 190.

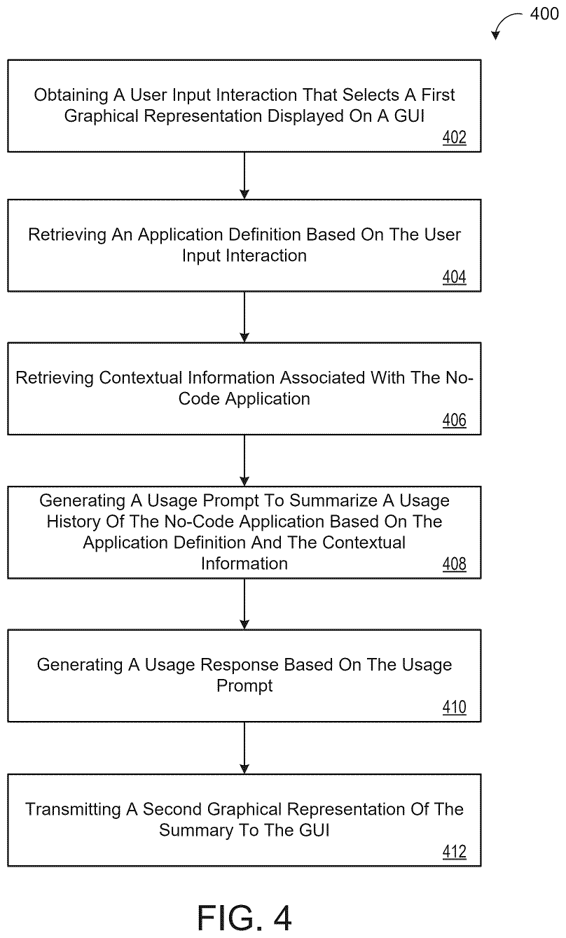

FIG. 4 is a flowchart of an exemplary arrangement of operations for a computer-implemented method 400 of providing guidance for no-code development platforms. The method 400 executed by data processing hardware 144 causes the data processing hardware 144 to perform operations. At operation 402, the method 400 includes obtaining a user input interaction 20 that selects a first graphical representation 122 displayed on a graphical user interface (GUI) 14. The first graphical representation 122 represents a no-code application 190. The no-code application 190 may be a single no-code application 190 or a plurality of no-code applications 190. At operation 404, the method 400 includes retrieving an application definition 172 based on the user input interaction 20. The application definition 172 includes a schema 174 and an application template 176 of the no-code application 190. At operation 406, the method 400 includes retrieving contextual information 182 associated with the no-code application 190. At operation 408, the method 400 includes generating a usage prompt 134 to summarize a usage history of the no-code application 190 based on the application definition 172 and the contextual information 182. At operation 410, the method 400 includes generating a usage response 164 based on the usage prompt 134. The usage response 164 includes a summary of the usage history of the no-code application 190. At operation 412, the method 400 includes transmitting, to the GUI 14, a second graphical representation 150 of the summary of the usage history of the no-code application 190.

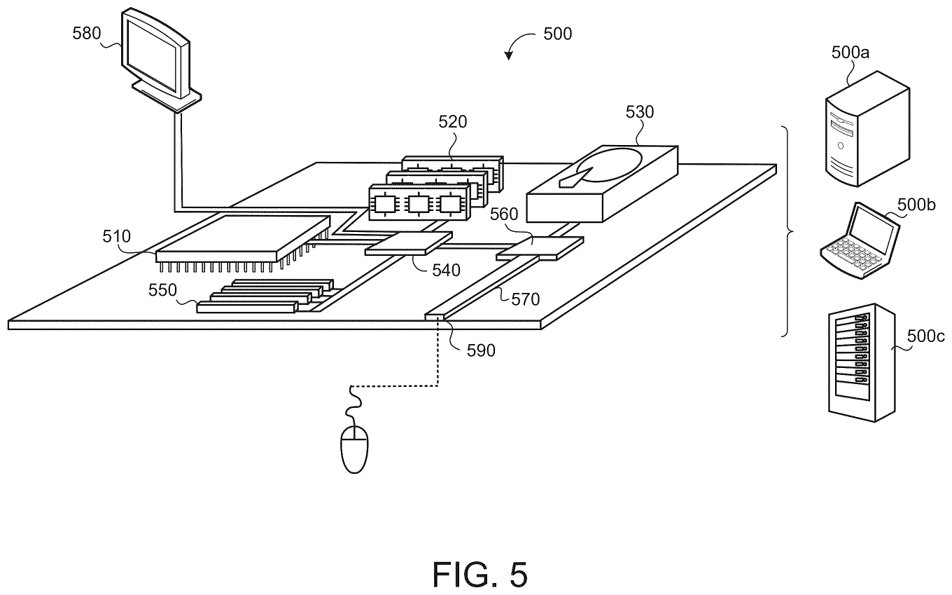

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes data processing hardware to perform operations comprising:
obtaining a user input interaction that selects a first graphical representation displayed on a graphical user interface (GUI), the first graphical representation representing a no-code application;
retrieving an application definition based on the user input interaction, the application definition comprising a schema and an application template of the no-code application;
retrieving contextual information associated with the no-code application;
generating a usage prompt to summarize a usage history of the no-code application based on the application definition and the contextual information;
generating a usage response based on the usage prompt, the usage response comprising a summary of the usage history of the no-code application; and
transmitting, to the GUI, a second graphical representation of the summary of the usage history of the no-code application.

2. The computer-implemented method of claim 1, wherein the contextual information comprises:
logs of usage data associated with the no-code application; and
version histories of the no-code application.

3. The computer-implemented method of claim 1, wherein the operations further comprise performing an action on the no-code application based on the usage response.

4. The computer-implemented method of claim 1, wherein the contextual information comprises configuration feature information associated with the no-code application.

5. The computer-implemented method of claim 4, wherein the operations further comprise:
generating a function prompt to summarize a function performed by the no-code application based on the configuration feature information; and
generating a function response based on the function prompt, the function response comprising a summary of the function of the no-code application.

6. The computer-implemented method of claim 1, wherein the contextual information comprises a set of policies and a subset of the set of policies applied to the no-code application.

7. The computer-implemented method of claim 6, wherein the operations further comprise:
generating a policy prompt to recommend policies from the set of policies for the no-code application;
generating a policy response based on the policy prompt, the policy response comprising a recommendation to apply one or more of the set of policies not applied to the no-code application; and
applying the one or more of the set of policies to the no-code application based on the policy response.

8. The computer-implemented method of claim 6, wherein the operations further comprise:
generating a policy prompt to recommend at least one policy from the subset of the set of policies to remove from the no-code application;
generating a policy response based on the policy prompt, the policy response comprising a recommendation to remove the at least one policy from the subset of the set of policies for the no-code application; and
removing the at least one policy from the subset of the set of policies from the no-code application based on the policy response.

9. The computer-implemented method of claim 1, wherein generating the usage prompt comprises applying one or more transformations to data associated with the no-code application.

10. The computer-implemented method of claim 1, wherein generating the usage response comprises generating the usage response using a pre-trained artificial intelligence (AI) model.

11. A system comprising:
data processing hardware; and
memory hardware in communication with the data processing hardware, the memory hardware storing instructions that when executed on the data processing hardware cause the data processing hardware to perform operations comprising:
obtaining a user input interaction that selects a first graphical representation displayed on a graphical user interface (GUI), the first graphical representation representing a no-code application,
retrieving an application definition based on the user input interaction, the application definition comprising a schema and an application template of the no-code application;
retrieving contextual information associated with the no-code application;
generating a usage prompt to summarize a usage history of the no-code application based on the application definition and the contextual information;
generating a usage response based on the usage prompt, the usage response comprising a summary of the usage history of the no-code application; and
transmitting, to the GUI, a second graphical representation of the summary of the usage history of the no-code application.

12. The system of claim 11, wherein the contextual information comprises:
logs of usage data associated with the no-code application; and
version histories of the no-code application.

13. The system of claim 11, wherein the operations further comprise performing an action on the no-code application based on the usage response.

14. The system of claim 11, wherein the contextual information comprises configuration feature information associated with the no-code application.

15. The system of claim 14, wherein the operations further comprise:
generating a function prompt to summarize a function performed by the no-code application based on the configuration feature information; and
generating a function response based on the function prompt, the function response comprising a summary of the function of the no-code application.

16. The system of claim 11, wherein the contextual information comprises a set of policies and a subset of the set of policies applied to the no-code application.

17. The system of claim 16, wherein the operations further comprise:
generating a policy prompt to recommend policies from the set of policies for the no-code application;
generating a policy response based on the policy prompt, the policy response comprising a recommendation to apply one or more of the set of policies not applied to the no-code application, and
applying the one or more of the set of policies to the no-code application based on the policy response.

18. The system of claim 16, wherein the operations further comprise:
generating a policy prompt to recommend at least one policy from the subset of the set of policies to remove from the no-code application;
generating a policy response based on the policy prompt, the policy response comprising a recommendation to remove the at least one policy from the subset of the set of policies for the no-code application; and
removing the at least one policy from the subset of the set of policies from the no-code application based on the policy response.

19. The system of claim 11, wherein generating the usage prompt comprises applying one or more transformations to data associated with the no-code application.

20. The system of claim 11, wherein generating the usage response comprises generating the usage response using a pre-trained artificial intelligence (AI) model.
